(19) United States
(12) Patent Application Publication
(10) Pub. No.: US 2002/0056934 A1
(43) Pub. Date: May 16, 2002

(54) Method for controlling injection molding machine capable of reducing variations in weight of molded products

(75) Inventor: Takeshi Konno, Chiba-shi (JP)

Correspondence Address: ARENT FOX KINTNER PLOTKIN & KAHN, PLLC, Suie 600, 1050 Connecticut Avenue, Washington, DC, 20036-5339, US

(73) Assignee: Sumitomo Heavy Industries, Ltd.

(21) Appl. No.: 09/987,345

(22) Filed: Nov. 14, 2001

(30) Foreign Application Priority Data
Nov. 15, 2000 (JP) 348194/2000

(51) Int. Cl. B29C 45/60; B29C 45/76

(52) U.S. Cl. 264/40.1; 264/328.1

(57) ABSTRACT

A synchronization ratio S of a rotation speed of a screw, in which the position of a flight thereof does not apparently move relative to a backward speed R of the screw, is defined as 100%. The screw is driven backward while being rotated. A rotation speed R of the screw during the backward movement is given by multiplying the rotation speed R, which is expressed by the equation, R=backward speed V/pitch P of the flight, by an arbitrary synchronization ratio Sx.

### BACKGROUND OF THE INVENTION

1. Field of the Invention

The present invention relates to a method for controlling a motor-driven injection molding machine.

2. Description of the Related Art

An injection molding machine comprises a screw located within a heating cylinder. An injection shaft is directly connected to the rear end portion of the screw. The injection shaft is rotatably supported by a pressure plate through some bearings. The injection shaft is driven in an axial direction by an injection servomotor that is supported on the pressure plate. The pressure plate moves forwards and backwards along guide bars in response to the operation of the injection servomotor through a ball screw.

A molding operation in the injection molding machine will be described, focusing on a motor-driven injection molding machine.

The screw is rotated by a measuring servomotor for screw rotation in a plasticization/measuring process. A resin is fed from a hopper to a rear portion of the screw in the heating cylinder. Rotation of the screw melts and advances the resin and thus a certain measured amount of resin is fed to a nose portion of the heating cylinder. During this time, the screw is driven backwards due to a back pressure of the molten resin trapped in the nose portion of the heating cylinder. The above-mentioned back pressure of the molten resin is detected by using a load cell and is controlled with a feedback control loop, as will be described in more detail below.

Then, in a filling process, the pressure plate is advanced by means of driving the injection servomotor. A nose portion of the screw serves as a piston to fill a cavity of a mold with the molten resin.

The resin within the cavity of the mold is allowed to cool under a predetermined pressure. This process is referred to as a dwelling process or a hold pressure process. In this hold pressure process, the pressure of the resin is controlled in a feedback control loop as in the above-mentioned back pressure control. Hereafter, the filling process and the hold pressure process continued from the filling process will collectively be called an injecting process.

Then, an injection device returns to the plasticization/measuring process after the completion of the hold pressure process. On the other hand, in a clamping device, an eject operation is carried out for ejecting a solid product out of the mold in parallel with the plasticization/measuring process. The eject operation involves the opening of the mold to remove the solid product from the mold by means of an ejector mechanism and then closing the mold for the injecting process.

Referring to FIGS. 1A and 1B, the screw will be specifically described. In FIG. 1A, a screw 20 comprises a feed section 20-1, a compressing section 20-2, a measuring section 20-3, and a head section 20-4. The feed section 20-1 feeds the resin supplied from a hopper forward in a solid or partly melted state. The resin is heated to close to melting point at the feed section 20-1. Therefore, in general, the diameter of the rod-shaped body of the screw 20 shown in FIG. 1B, which forms a spiral thereon, is substantially constant. The spiral is typically called a flight.

There is a space between particles of the resin fed from the feed section 20-1, and the compressing section 20-2, so that the volume is reduced to approximately a half due to melting of the resin. In order to compensate for the reduced volume, the space through which the resin can pass is reduced. This is achieved by providing a taper on the rod-shaped body which forms the flight at the compressing section 20-2 so that a groove of the flight is shallow. Consequently, the compressing section 20-2 compresses the molten resin, increases the effect of frictional heating, and increases the pressure of the resin, thereby moving water components, volatile gases, or the like, which are contained in the air/resin, back to the hopper. As is evident from the above, the pressure of the resin in the heating cylinder is highest in the compressing section 20-2.

The measuring section 20-3 has the shallowest groove of the flight. In the measuring section 20-3, the resin is subjected to a large shearing force and its temperature is increased to a uniform temperature by self-generating heat due to friction. Also, the measuring section 20-3 feeds a certain measured amount of resin to a nozzle side.

The molten resin is fed from the measuring section 20-3 to the nozzle side via a nonreturn ring 20-5 at the head section 20-4. The nonreturn ring 20-5 is positioned at the left-hand side of FIGS. 1A and 1B in the measuring process. In this state, the molten resin can be fed from the measuring section 20-3 to the nozzle side. After completion of the measuring process, the nonreturn ring 20-5 is moved to the right-hand side of the drawings because of pressure difference. As a result, the return of the resin from the nozzle side to the measuring section 20-3 is stopped. In general, the head section 20-4 is constructed in such a manner that a screw thread is cut at the base thereof and is screwed into an end portion of the rod-shaped body of the screw. Therefore, the diameter of the base portion of the head section 20-4 is smaller than that of the rod-shaped body of the screw.

Meanwhile, there may be cases where the screw is driven backward in the molding cycle, for the following reasons:

A: Moving the screw backwards for the purpose of depressurizing after completion of the injecting process.

B: Measuring the resin.

C: Moving the screw backwards after measuring process.

Conventionally, the screw is not rotated in the case of A and C.

As is schematically shown in FIG. 2, when the screw 20 is driven backwards, since the resin is applied to the flight, the resin is also likely to be dragged backwards together with the flight. Accordingly, a uniform distribution of the volume and density of the resin is hampered at the nose portion of the screw 20. This leads to a nonuniform weight of the molded products.

### SUMMARY OF THE INVENTION

Accordingly, it is an object of the present invention to provide a method for controlling an injection molding machine in which the influence on a resin during a backward movement of a screw, and more particularly, the influence on the distribution of the density of the resin can be cancelled.

The present invention can be applied to an injection molding machine comprising a heating cylinder and a screw disposed in the heating cylinder, and performing a plasticization/measuring process and an injecting process. In a method for controlling the injection molding machine according to the present invention, a synchronization ratio S of a rotation speed of the screw is defined to be 100% when the position of a flight thereof does not apparently move relative to a backward speed V of the screw, wherein the method comprises the step of moving the screw backward while rotating it after completion of the measuring process or the injecting process, and wherein a rotation speed R of the screw during the backward movement is given by multiplying the rotation speed R, which is expressed by the equation, R=backward speed V/pitch P of the flight, by an arbitrary synchronization ratio Sx.

### BRIEF DESCRIPTION OF THE DRAWINGS

FIGS. 1A and 1B are explanatory views showing a typical example of a screw in an injection molding machine;

FIG. 2 is a schematic diagram explaining the relationship between the screw and resin in a heating cylinder;

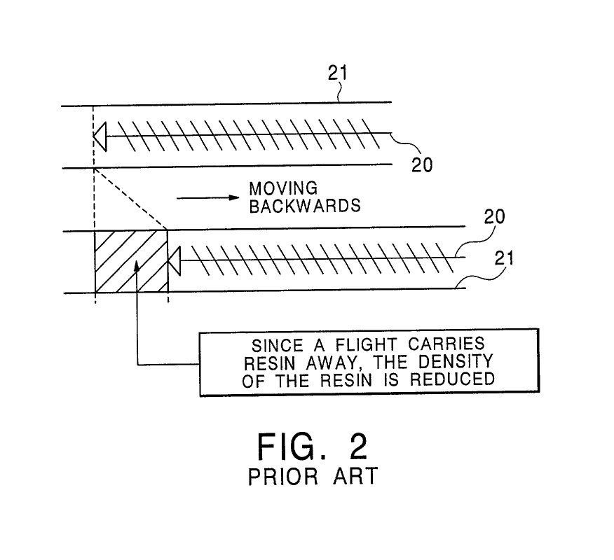

FIG. 3 is a view showing a structure of a motor-driven injection molding machine according to the present invention, focusing on an injection unit; and

FIGS. 4A and 4B are schematic diagrams showing the relationship between the screw and the resin in a heating cylinder to explain a preferred embodiment of the present invention.

### DESCRIPTION OF THE PREFERRED EMBODIMENTS

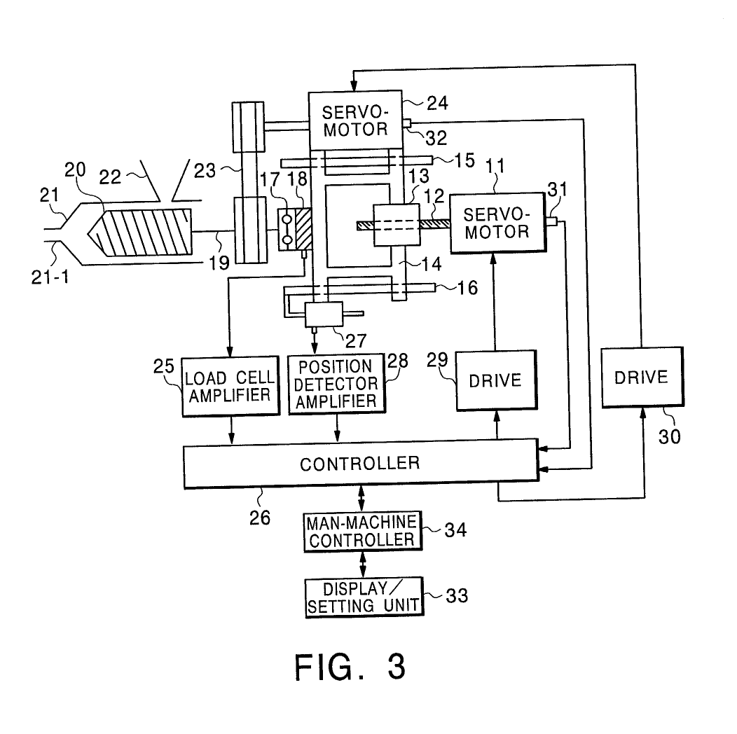

Referring to FIG. 3, a motor-driven injection molding machine will be described focusing on an injection unit. The motor-driven injection molding machine is provided with the injection unit driven by a servomotor. In such an injection unit, rotation of the servomotor is converted into linear motion by a ball screw and a nut, thereby moving a screw forward and backward.

In FIG. 3, the rotation of an injection servomotor 11 is transmitted to a ball screw 12. A nut 13 is fixed on a pressure plate 14 and is moved forward and backward by rotation of the ball screw 12. The pressure plate 14 is movable along four guide bars 15 and 16 (only two are shown in the figure) fixed on a base frame (not shown). Forward and backward movement of the pressure plate 14 is transmitted to a screw 20 via a bearing 17, a load cell 18, and an injection shaft 19. The screw 20 is disposed in a heating cylinder 21 such that rotary and axial movement can be achieved. The heating cylinder 21 includes a hopper 22 for feeding a resin to a position corresponding to a rear portion of the screw 20. Rotary motion of a servomotor 24 for rotating the screw 20 is transmitted to the injection shaft 19 via a connecting member 23 which may be a belt, pulleys, etc. In other words, the servomotor 24 rotates the injection shaft 19 which in turn rotates the screw 20.

In a plasticization/measuring process, the screw 20 rotates and moves backwards in the heating cylinder 21, so that a molten resin is moved in a feed forward direction and that the molten resin is stored in front of the screw 20, that is, at a nozzle 21-1 side in the heating cylinder 21. The backward movement of the screw 20 is caused by pressure due to a gradual increase in the amount of molten resin stored in front of the screw 20.

In an injecting process, the forward movement of the screw 20 in the heating cylinder 21 is caused by driving force from the injection servomotor 11, so that the molten resin stored in front of the screw 20 is forced into and is pressurized in a metal mold. In this case, the force required for pressing the molten resin is detected by the load cell 18 as an injection pressure. The detected injection pressure is amplified by a load cell amplifier 25 and is fed into a controller 26. The pressure plate 14 has a position detector 27 to detect the amount of movement of the screw 20. The detecting signal outputted from the position detector 27 is amplified by a position detector amplifier 28 and is fed into the controller 26.

The controller 26 outputs current (torque) instruction values corresponding to the respective processes and based on values preset by a display/setting unit 33 via a man-machine controller 34. The current instruction values are fed to a drive 29 and a drive 30. The drive 29 controls a current for driving the servomotor 11 to control an output torque of the servomotor 11. The drive 30 controls a current for driving the servomotor 24 to control the number of revolutions of the servomotor 24. The servomotor 11 and the servomotor 24 comprise encoders 31 and 32, respectively, to detect the number of revolutions. The number of revolutions detected by the encoders 31 and 32 is fed to the controller 26. In particular, the number of revolutions detected by the encoder 32 is used to determine the number of revolutions of the screw 20.

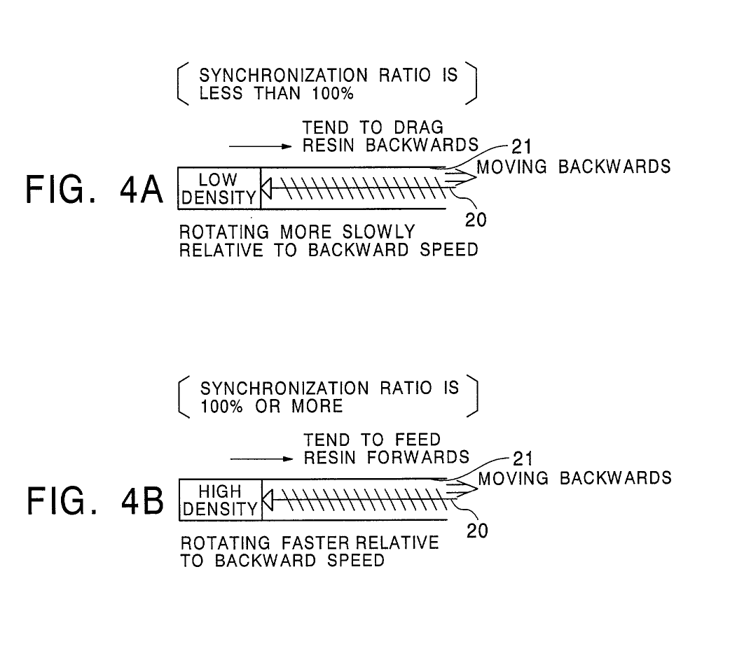

Referring to FIGS. 4A and 4B, a control method according to a preferred embodiment of the present invention will be described. The control method according to the present invention is applied to the injection molding machine shown in FIG. 3. The controller 26 receives the detecting signals from the position detector 27 and the encoders 31 and 32, controls the servomotors 11 and 24, and also controls the plasticization/measuring process and injecting process. Also, the controller 26 carries out the control method according to the present invention, which will be described hereinbelow.

In this embodiment, the screw 20 is rotated and moved backwards after completion of the measuring process or the injecting process. In other words, the screw 20 is moved linearly backwards relative to the feed forward direction of the molten resin. Particularly, a synchronization ratio S of the rotation speed at which a flight 20a of the screw 20 does not apparently move relative to a backward speed V of the screw 20 is defined as 100%. The synchronization ratio S can be set from 0% to an arbitrary percentage, and each of settings to 100% or more and setting to less than 100% has the following purpose:

The synchronization ratio S is less than 100%: This setting is performed for the purpose of dragging the resin backwards with the flight of the screw 20, as shown in FIG. 4A.

The synchronization ratio S is 100% or more: this setting is performed for the purpose of feeding the resin forward, that is, for measuring the resin, as shown in FIG. 4B. However, the measuring is performed at a constant rotation speed irrespective of the pressure of the resin when the screw moves backwards at a constant speed, and is different from a conventional control for maintaining the pressure of the resin constant. This operation prevents generation of a low density region during backward movement of the screw 20.

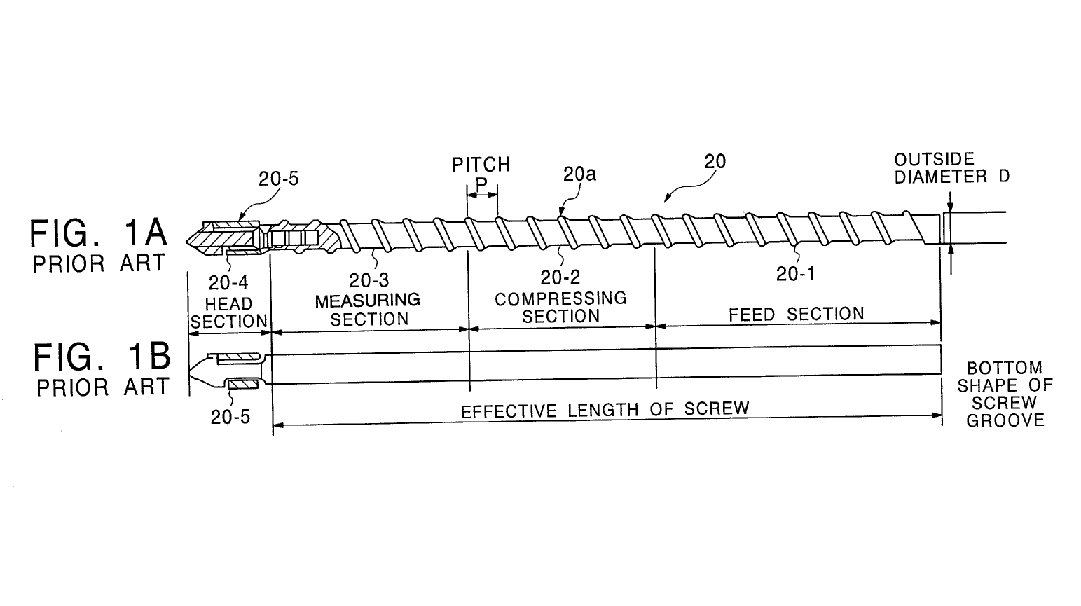

When the spacing (pitch P in FIG. 1A) between the flights of the screw 20 is 20 mm, for example, the flight moves by 20 mm on each rotation of the screw. In this instance, if the screw 20 moves backwards at a speed of 20 mm/sec, the flight of the screw 20 is apparently at a fixed position when the screw 20 rotates one turn per one second. However, the direction of the rotation depends on the direction of the rotation of the flight in the screw 20. if the flight in the screw 20 is the clockwise direction, the direction of the rotation is the clockwise direction.

This is expressed by the following equation:

Rotation speed R (rpm)=[Backward speed V (mm/sec)]/Pitch P (mm) of the flight]×60

Where, when the synchronization ratio S is multiplied by the rotation speed R which is obtained by the equation, a consistent state of the resin can be controlled during the backward movement of the screw 20. Namely, a selected rotation speed Rs is given by the following equation by the use of a selected synchronization ratio Sx.

Rs=(V/P)×Sx.

The present invention is not limited to the motor-driven injection molding machine shown in FIG. 3, and may also be applied to a hydraulic injection molding machine. In this case, a hydraulic piston mechanism is used instead of the injection servomotor 11.

According to the present invention, when the screw is moved backward, the screw is rotated at an arbitrary rotation speed, and thus, the density distribution of the resin in the heating cylinder, particularly at the nose portion of the screw, can be sufficiently controlled so that variations in the weight of the molded products can be reduced.

What is claimed is:

1. A method for controlling an injection molding machine including a heating cylinder and a screw disposed in the heating cylinder, and performing a plasticization/measuring process and an injecting process, said method comprising the steps of:
defining a synchronization ratio S of a rotation speed of the screw to be 100% when the position of a flight thereof does not apparently move relative to a backward speed V of the screw; and
moving the screw backwards while rotating it after completion of the measuring process or the injecting process;
wherein a rotation speed R of the screw during the backward movement is given by multiplying the rotation speed R, which is expressed by the equation, R=backward speed V/pitch P of the flight, by an arbitrary synchronization ratio Sx.

2. A method for controlling the injection molding machine according to claim 1,
wherein, when the synchronization ratio S is less than 100%, the screw is rotated more slowly relative to the backward speed V of the screw, so that a resin in the heating cylinder tends to be dragged backwards with the flight of the screw; and
wherein, when the synchronization ratio S is 100% or more, the screw is rotated faster relative to the backward speed V of the screw, so that the resin in the heating cylinder tends to be fed forward of the screw.

3. A method for controlling an injection molding machine including a heating cylinder, a screw disposed in the heating cylinder, a first driving source for driving the screw in an axial direction, a second driving source for rotating the screw, position detecting means for detecting an axial position of the screw, rotation-speed detecting means for detecting the rotation speed of the screw, and a controller for controlling the first driving source and the second driving source dependent on the detecting signals transmitted from the position detecting means and the rotation-speed detecting means, and performing a plasticization/measuring process and an injecting process, said method comprising the steps of:
defining a synchronization ratio S of a rotation speed of the screw to be 100% when the position of a flight thereof does not apparently move relative to a backward speed V of the screw,
wherein the controller moves the screw backwards while rotating it after the completion of the measuring process or the injecting process; and
wherein a rotation speed R of the screw during the backward movement is given by multiplying the rotation speed R, which is expressed by the equation, R=backward speed V/pitch P of the flight, by an arbitrary synchronization ratio Sx.

4. A method for controlling the injection molding machine according to claim 3,
wherein, when the synchronization ratio S is less than 100%, the controller generates a tendency to drag a resin in the heating cylinder backward with the flight of the screw by rotating the screw more slowly relative to the backward speed V of the screw; and
wherein, when the synchronization ratio S is 100% or more, the controller generates a tendency to feed the resin in the heating cylinder forward of the screw by rotating the screw more faster relative to the backward speed V of the screw.

5. A method for controlling an injection molding machine in order to perform a resin plasticization/measuring process and an injecting process, wherein:
the injection molding machine includes a heating cylinder and a screw having a flight of a pitch P, the screw being arranged within the heating cylinder;
the method comprising the step of defining a synchronization ratio S with reference to a rotation speed R and a linear backward speed V of the screw, the synchronization ratio S being equal to 100% when the flight does not apparently move while the screw is rotated and linearly moved backwards, the synchronization ratio S being smaller than 100% when the flight moves backwards while the screw is rotated and linearly moved backwards, the synchronization ratio S being greater than 100% when the flight moves forwards while the screw is rotated and linearly moved backwards;
the method further comprising the step of making the screw linearly move backward at a selected synchronization ratio Sx and simultaneously rotate after completion of the plasticization/measuring process or the injecting process;
a selected rotation speed Rs of the screw being given by:
Rs=(V/P)×Sx.

6. A method for controlling the injection molding machine according to claim 5, wherein:
the resin in the heating cylinder tends to be dragged backwards with the flight of the screw when the selected synchronization ratio Sx is smaller than 100%;
the resin in the heating cylinder tends to be fed forward of the screw relative to the backward movement of the screw when the selected synchronization ratio Sx is not smaller than 100%.

7. A method for controlling an injection molding machine in order to perform a resin plasticization/measuring process and an injecting process, wherein:
the injection molding machine includes a heating cylinder, a screw having a flight of a pitch P and arranged within the heating cylinder, a first driving source for driving the screw in an axial direction, a second driving source for rotating the screw, a position detecting device for detecting an axial position of the screw, a rotation-speed detecting device for detecting the rotation speed of the screw, and a controller for controlling the first and the second driving sources in response to detecting signals transmitted from the position detecting device and the rotation-speed detecting device;
the method comprising the step of defining a synchronization ratio S with reference to a rotation speed R of the screw and a linear backward speed V of the screw, the synchronization ratio S being equal to 100% when the flight does not apparently move while the screw is rotated and linearly moved backwards, the synchronization ratio S being smaller than 100% when the flight moves backwards while the screw is rotated and linearly moved backwards, the synchronization ratio S being greater than 100% when the flight moves forwards while the screw is rotated and linearly moved backwards;
the method further comprising the step of controlling the movement so that the screw is linearly moved backward at a selected synchronization ratio Sx and simultaneously controlling the rotation of the screw, after completion of the plasticization/measuring process or the injecting process;
a selected rotation speed Rs of the screw being given by:
Rs=(V/P)×Sx.

8. A method for controlling the injection molding machine according to claim 7, wherein:
the controller controls the movement of the screw so that the resin in the heating cylinder tends to be dragged backwards with the flight of the screw, when the selected synchronization ratio Sx is smaller than 100%;
the controller controls the movement of the screw so that the resin in the heating cylinder tends to be fed forward of the screw relative to the backward movement of the screw, when the selected synchronization ratio Sx is not smaller than 100%.

9. A method for controlling an injection molding machine in order to control the movement of a molten resin in a heating cylinder of the injection molding machine, the injection molding machine including a screw arranged within the heating cylinder to be rotatable and to be linearly movable and having a flight of a pitch P, the molten resin being moved in a forward feeding direction during a plasticization process and an injecting process;
the method comprising the step of linearly moving the screw backwards relative to the forward feeding direction of the molten resin and simultaneously rotating the screw in the forward feeding direction, after completion of the plasticization process or the injecting process.

10. A method for controlling an injection molding machine according to claim 9, wherein, when the screw linearly moves backward, the screw moves at a linear backward speed V and a rotation speed R in the forward feeding direction to define a synchronization ratio S based on the rotation speed R of the screw and the linear backward speed V of the screw, the synchronization ratio S being equal to 100% when the flight does not apparently move while the screw is rotated and linearly moved backwards in the forward feeding direction, the synchronization ratio S being smaller than 100% when the flight moves backwards while the screw is rotated and linearly moved backwards in the forward feeding direction, the synchronization ratio S being greater than 100% when the flight moves forwards while the screw is rotated and linearly moved backwards in the forward feeding direction.

11. A method for controlling an injection molding machine according to claim 10, wherein a selected rotation speed Rs of the screw being given by:
Rs=(V/P)×S.

12. A method of controlling an injection molding machine according to claim 10, wherein:
the resin in the heating cylinder tends to be dragged backwards relative to the forward feeding direction with the flight of the screw when a selected synchronization ratio Sx is smaller than 100%;
the resin in the heating cylinder stays there when the selected synchronization ratio Sx is equal to 100%;
the resin in the heating cylinder tends to be fed forward of the screw relative to the forward feeding direction when the selected synchronization ratio Sx is greater than 100%.
